(19) United States
(12) Patent Application Publication
(10) Pub. No.: US 2006/0103892 A1
(43) Pub. Date: May 18, 2006

(54) System and method for a vector difference mean filter for noise suppression

(76) Inventors: Mark A. Schulze, Austin, TX (US); George John, Austin, TX (US)

Correspondence Address: ANDERSON & JANSSON, L.L.P., 9501 N. CAPITAL OF TX HWY. #202, AUSTIN, TX, 78759, US

(21) Appl. No.: 10/992,409

(22) Filed: Nov. 18, 2004

(51) Int. Cl. H04N 1/38

(52) U.S. Cl. 358/463

(57) ABSTRACT

Reduction of noise in digitized multi-spectral images is provided by filtering based on vector values rather than independent scalar values. Vector values refer to a pixel with two or more values. For this method, a metric is defined for pixel vector magnitude. A sliding processing kernel is also defined, with a specified shape, a specified number of pixels to be included in the kernel, and a specified value contrast threshold to avoid distorting edges and fine details. The metric and kernel are used to select pixels for computing filtering of the center pixel in a kernel. A statistical measurement is computed, for example by mean averaging the specified pixels, and the resulting value is made the value of the center pixel of the kernel. The filtering process is applied throughout the image by making each pixel the center of a processing kernel.

### FIELD OF THE INVENTION

The present invention relates generally to the field of processing image data, and more particularly to a system and method for processing image data to suppress noise.

### BACKGROUND OF THE INVENTION

Methods for capturing digital images by devices such as cameras and scanners, compressing those images, transmitting them to remote locations, and further processing them typically create disturbances in the images called “noise.” For example, FIG. 1 shows the red, green, and blue pixel values for a common section of a digital image. The combined values for a sample pixel, pixel 1 610, within the section would be [1 1 2] (1 for red, 1 for green, and 2 for blue). However, limitations in the sensor involved in capturing the image might cause a distorted output of 2 for the green value of pixel 610, as shown in FIG. 2, so that the combined values for that pixel would be [1 2 2].

Such noise throughout the pixels of an image may detract from the image's quality and may cause difficulties in further processing that image to modify it for corrections, enhancements, and other changes. Accordingly techniques have been developed for reducing noise in digital images, which can be classified as follows:

Spatial filtering—primarily through linear averaging filters,

Frequency filtering,

Wavelet filtering, and

Mathematical morphology filtering.

Of these techniques, spatial filtering is the category under which the present invention fall.

For an example of a prior technique of spatial filtering, U.S. application 20040114055 for Chiu describes an accelerative noise filtering method for image data, whereby four neighboring pixels are selected around a target pixel in a pattern of a cross shape or X shape to form a processing kernel. A statistical threshold is imposed as follows. The absolute value of a difference between the target pixel and each of the four neighboring pixels in the kernel is calculated. A binary value of a bit corresponding to the neighboring pixel is set to “1”, when the absolute value of the difference of the neighboring pixel is not larger than a standard deviation. When the absolute value of the difference of the neighboring pixel is larger than a standard deviation, a binary value of a bit corresponding to the neighboring pixel is set to “0”. Consequently, a 4-bit mapping table including the binary values of the four neighboring pixels is obtained. Then a new pixel value for replacing the target pixel value is calculated based on a calculation derived from the 4-bit mapping table.

To cite another example of spatial filtering, U.S. Pat. No. 6,625,325 for Gindele describes a method for processing a sparsely populated single value digital image from a color filter array to produce a fully populated and noise clean color image. It includes noise cleaning the sparsely populated image using a variable noise cleaning processing kernel and a statistical threshold to provide a noise clean sparsely populated color digital image. It also employs interpolating the noise clean sparsely populated image for producing color pixels with appropriate values missing from the sparsely populated color digital image by interpolating the color values for missing pixels from neighboring color pixels

Prior techniques such as the ones given above, using simple averaging filters or other linear filters to supply replacement values for pixels with probable noise, may be effective at reducing overall noise. In the green area in FIG. 2, for example, mean averaging the eight pixels around pixel 1 620, all of which have the value one, would return an accurate replacement value of one for pixel 1 620.

However, such techniques typically do not do a good job of preserving edges and fine details 30 in images. For example, methods that average pixel values to remove noise typically soften edges and fine details in low-noise images. One reason for this is because low-noise images have large low-value areas but edges and fine details in those images have high values.

In FIG. 3A, for example, which shows the red and green pixel values for a common area of an image, the red values 511 change dramatically for an edge captured in the image at edge spike 1 640, from 1 to 5. The green values 521 for the same edge change more weakly at edge spike 2 650, from 1 to 2.

Though prior spatial filtering techniques like those in the patent and patent application given above differ in details such as processing kernel size and shape, they typically reduce noise for each color value separately, by
Selecting surrounding pixel values within a defined kernel area;
Subtracting the selected pixel values from the center pixel in each kernel;
Applying a set value contrast threshold to the selected pixel values;
Using a statistical measurement such as mean averaging to determine a replacement pixel value; and
Making that replacement pixel value the value of the center pixel of each kernel.

For the areas shown in FIG. 3A, where the kernel is three pixels by three pixels, such spatial filtering would produce the following results. For the red values 511, every pixel value would be subtracted from the center pixel value, which is 5. For the green values 521, every pixel value would be subtracted from 2. FIG. 3B shows the results of this subtraction.

A value contrast threshold, for example a value of 2, is then applied to correct for edges, which removes sharply contrasting values. In this case, the pixels with values of 4 (which are above 2) in the red values 511 are considered sharply contrasting values 512 and are eliminated from the selected set of pixels.

FIG. 3C shows the original pixel values for the remaining selected areas. Mean averaging of the red values 511 (30/6) would then result in 5 being used as the value for the center pixel, which is the same as the previous value (5) for the center pixel, shown in FIG. 3A.

But the result of mean averaging of the green values 521 (15/9), shown in FIG. 3C is 1.7. A replacement value of 1.7 for the center pixel is a softening of the original value of 2, shown in FIG. 3A, representing a softening of the edge, so that the overall color edge is softened.

Filtering of an entire low-noise image based on averaging independent layers will thus typically result in lower values for edges than is accurate and, additionally, can lead to unwanted color artifacts in the image through such softening.

The same statement applies to a low-noise image with fine details. For example, FIG. 3D shows the red and green pixel values for a common area of an image in which the red values 514 change dramatically, from 1 to 4, for a fine detail captured in the image at fine detail spike 1 652. The green values 524 for the same fine detail also change at fine detail spike 2 654, from 1 to 2. The same averaging process outlined above would yield a value of 4 for the center pixel of the red values 514, but would yield 1.3 for the center pixel of the green values 524, which is a softening from 2.

In addition, even newer, nonlinear spatial filtering methods that perform reasonably well at preserving edges and details usually modify and distort the image significantly, even if the image is virtually noise-free. In particular, prior filtering techniques for reducing noise cause distortion in multi-valued (color or multi-spectral) images because these techniques separately adjust the individual color values (red, green, and blue) of pixels instead of adjusting the vector values as a whole. Vector values comprise a plurality of spectral components represented by scalar values. Examples of these spectral components include

Color such as RGB (red, green, and blue); and

Color such as CMYK (cyan, magenta, yellow, and black).

For example, edge spike 1 640 in the red values in FIG. 3A shows a jump from 1 to 5 and edge spike 2 650 shows a jump from 1 to 2 in the green values. However, the filtered values derived through the mean averages performed above preserve the jump from 1 to 5 in the red values but the show a smaller jump from 1 to 1.7 in the green values. Thus filters that supply replacement values through averaging surrounding pixels in separate color areas cause image distortions because they distort the balance among the separate areas of color.

Therefore there is a need for a system and method for processing image data to suppress noise that preserves edges and details in a wide range of images and does not distort the images.

### BRIEF SUMMARY OF THE INVENTION

These and other needs are addressed by the present invention. The following explanation describes the present invention by way of example and not by way of limitation.

It is an aspect of the present invention to provide a system and method for processing image data to suppress noise that preserves edges and details in a wide range of images and does not distort the images.

It is another aspect of the present invention to reduce noise in digitized multi-spectral images by filtering based on vector values rather than on independent scalar values such as red, green, and blue in the case of color images.

These and other aspects, features, and advantages are achieved according to the method and system of the present invention. In accordance with the present invention, reduction of noise in digitized multi-spectral images is provided by filtering based on vector values rather than independent scalar values. Vector values refer to a pixel with two or more values. For this method, a metric is defined for pixel vector magnitude. A sliding processing kernel is also defined, with a specified shape, a specified number of pixels to be included in the kernel, and a specified value contrast threshold to avoid distorting edges and fine details. The metric and kernel are used to select pixels for computing the filtered value of the center pixel in a kernel. A statistical measurement is computed, for example by mean averaging the specified pixels, and the resulting value is made the value of the center pixel of the kernel. The filtering process is applied throughout the image by making each pixel the center of a processing kernel.

### BRIEF DESCRIPTION OF THE DRAWINGS

The following embodiment of the present invention is described by way of example only, with reference to the accompanying drawings, in which:

FIG. 1 is a block diagram that illustrates the red, green, and blue pixel values for a common section of a digital image;

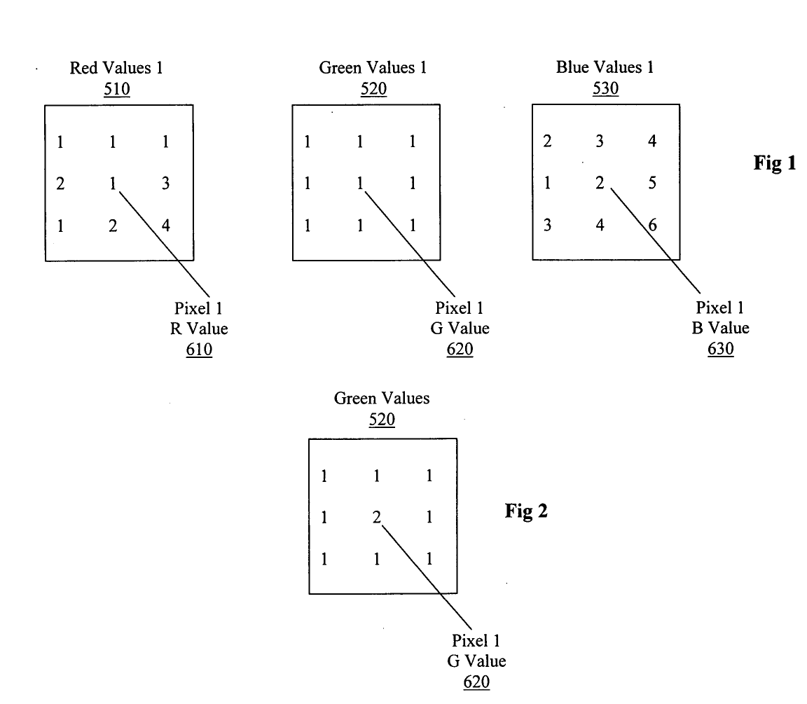

FIG. 2 is a block diagram that illustrates noise in an image;

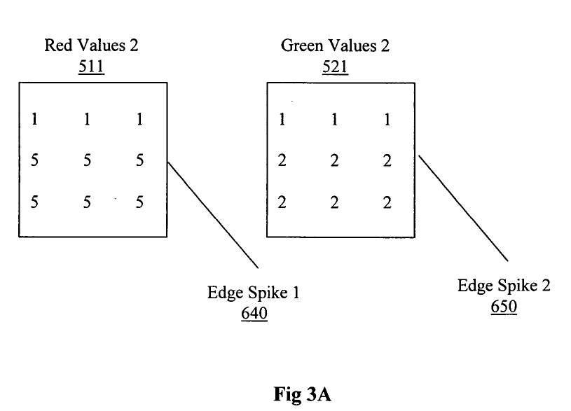

FIG. 3A is a block diagram that shows the red and green pixel values for a common area of an image containing an edge spike;

FIG. 3B is a block diagram that shows the red and green pixel values for a common area of an image containing an edge spike, after subtracting every value from the center pixel, in each color area;

FIG. 3C is a block diagram that shows the red and green pixel values for a common area of an image containing an edge spike, after applying a value contrast threshold of 2;

FIG. 3D is a block diagram that shows the red and green pixel values for a common area of an image containing an fine detail spike;

FIG. 4 is a block diagram showing an operating environment in which embodiments of the present invention may be employed;

FIG. 5A is a flow chart that illustrates at a high-level a process for reduction of noise in digital images by filtering based on vector values;

FIG. 5B is a flow chart that illustrates a process used for creating filtering software;

FIG. 5C is a flow chart that shows a process used for defining a sliding processing kernel;

FIGS. 6A, 6B, 6C, 6D, and 6E are block diagrams that illustrate the sliding use of a kernel for reducing noise pixel by pixel throughout an image;

FIG. 7A is a block diagram that shows the vector values for the pixels in a kernel of a digital image;

FIG. 7B is a block diagram that shows the categorization of vector values in columns for x, y, and z values;

FIG. 8A is a block diagram that shows the values derived by a metric for all the pixels in a kernel;

FIG. 8B is a block diagram that shows the pixels in a kernel that have derived values below a contrast value threshold of 2.5 and that will be used as the specified set of pixels for filtering a center pixel by averaging;

FIG. 9 is a block diagram that shows the vector values of a set of pixels specified according to a contrast value threshold;

FIG. 10 is a block diagram that shows the use of a statistical measurement as a filtered value for a center pixel in a kernel;

FIG. 11 is a block diagram that illustrates a low magnitude image and a high magnitude image;

FIG. 12 is a block diagram that illustrates red and green values of an image;

FIG. 13 is a flow chart that shows a process for sharpening images by enhancing image detail by using the present invention;

FIG. 14 is a block diagram that illustrates a typical computer; and

FIG. 15 is a block diagram that shows an alternate operating environment in which embodiments of the present invention may be employed.

### DETAILED DESCRIPTION

The details of the following explanation are offered to illustrate the present invention clearly. However, it will be apparent to those skilled in the art that the concepts of the present invention are not limited to these specific details. Commonly known elements are also shown in block diagrams and flow charts for clarity, as examples and not as limitations of the present invention.

Overview

The present invention provides reduction of noise in digitized multi-spectral images by filtering based on vector values. As a result, the present invention can be used to reduce noise in multi-valued (i.e. color or multi-spectral) images and does well at removing noise that is visible in relatively homogeneous areas in an image. The invention is also especially well-suited for images that have fine details and/or sharp edges that need to be preserved, and may be used on both noisy and noise-free images without fear of distorting the noise-free images. Moreover, the invention allows the adjustment of parameters to fine-tune the operation of the filter, such parameters comprising kernel size and shape and value contrast threshold values.

Operating Environment

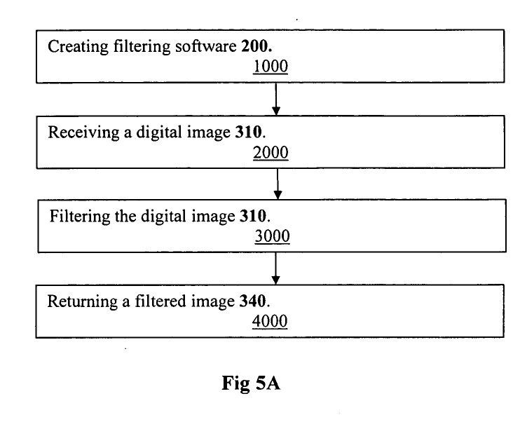

An embodiment of an operating environment of the present invention is shown in FIG. 4. One or more programmers at a computing environment 100 create filtering software 200, employing the techniques of the present invention, explained in detail below.

Multiple remote devices, for example computer 150, camera 1 160, and cell phone (cellular telephone) 170, equipped with camera 2 180, can employ wired or wireless links 144, 146, and 148, network 130, and a wired or wireless link 142 to communicate with computing environment 100, and server 100 can use the same system to communicate with these devices. Computing environment 100 may be, for example, a personal computer or a larger computerized system or combination of systems. The network 130 may be the Internet, a private LAN (Local Area Network), a wireless network, a TCP/IP (Transmission Control Protocol/Internet Protocol) network, or other communications system, and can comprise multiple elements such as gateways, routers, and switches. Links 142, 144, 146, and 148 use technology appropriate for communications with network 130.

Through the operating environment shown in FIG. 4, computer 150 can send digital image 1 310 to server 100 to be processed for noise reduction. Server 100 receives digital image 1 310 and automatically holds it in volatile memory and processes it with filtering software 100 to produce filtered image 1 340, in which noise is suppressed. Server 100 then automatically transmits filtered image 1 340 to computer 150.

Similarly, camera 1 160 can send digital image 2 320 to server 100 for noise reduction, and cell phone 170 can send digital image 3 330. Server 100 can then process these images and send filtered image 2 350 to camera 1 160 and filtered image 3 360 to cell phone 170.

Process

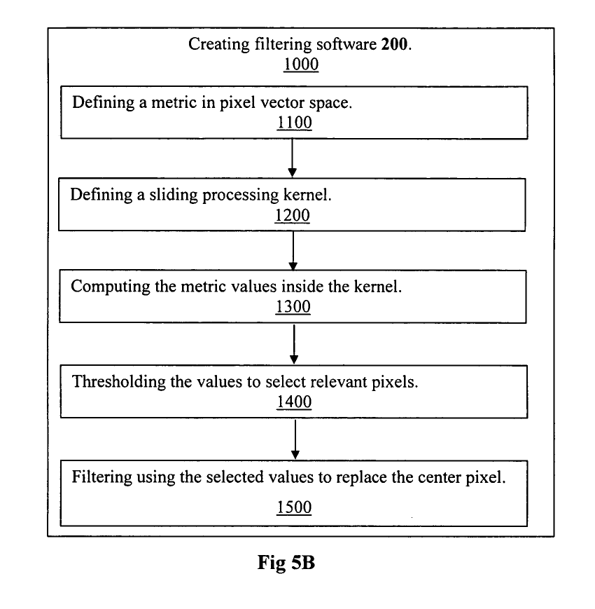

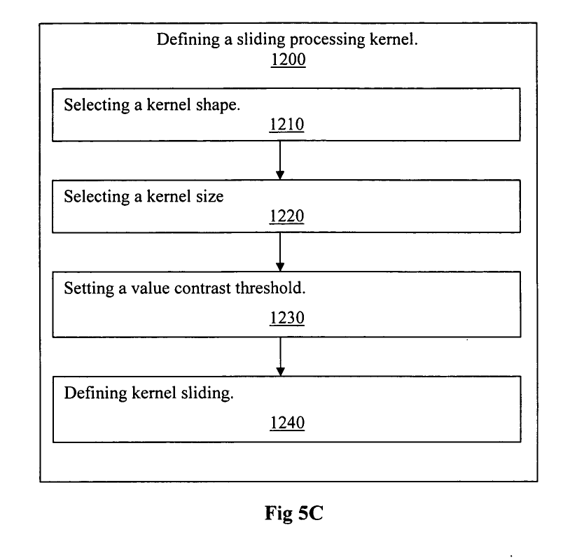

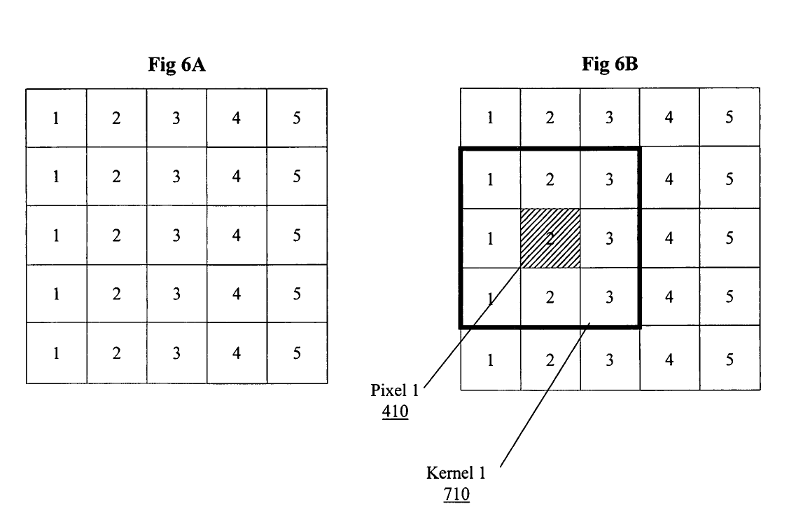

FIG. 5A is top-level flow chart that illustrates an embodiment of a process for reduction of noise in digital images by filtering based on vector values through the operating environment shown in FIG. 4. It will be useful to explain these elements briefly from a high level and then to expand them in detail. The steps in this process are the following:

Step 1000—Creating filtering software 200;

Step 2000—Receiving a digital image 310;

Step 3000—Filtering the digital image 310; and

Step 4000—Returning a filtered image 340.

Creating Filtering Software

In an embodiment, one or more programmers at server 100, shown in FIG. 4, create filtering software 200 for use on server 100. In another embodiment, filtering software 200 may created on one server and loaded onto any other server for use on that other server.

FIG. 5B illustrates the process used for creating filtering software 200 in Step 1000, shown in FIG. 5A.

Step 1100—Defining a metric in pixel vector space;

Step 1200—Defining a sliding processing kernel;

Step 1300—Computing the metric values inside the kernel;

Step 1400—Thresholding the values to select relevant pixels; and

Step 1500—Filtering using the selected values to replace the center pixel.

Defining a Metric in Pixel Vector Space

For images that have multiple values at each pixel (e.g., color or multi-spectral images), the metric may be a variety of different measurements of the distance between pixel values. One useful metric in that case is the simple vector distance between the values in their native coordinate space (for example, RGB space for color images).

In an embodiment, the following metric is particularly useful for determining vector distance:
\sqrt{(x₁−x₂)²+(y₁−y₂)²+(z₁−z₂)²}
where x, y, and z represent pixel vector values.

In another embodiment, the following metric is also useful:
|x₁−x₂|+|y₁−y₂|+|z₁−z₂|
Defining a Sliding Processing Kernel

A sliding processing kernel of arbitrary shape and size is defined, and the pixels within the filtering threshold are included in the set of pixels that will be used to compute the filter output for each kernel. The kernel is moved by filtering software 200, shown in FIG. 4, across the image at every pixel, each pixel forming the center of a kernel, including when the pixel in on the edge of the image, as explained below. Filtering for noise reduction is accomplished for each center pixel, based on the average of the vector values of the pixels in the kernel that surround each center pixel.

FIG. 5C shows the process used for defining a sliding processing kernel in an embodiment. In other embodiments, the steps may be performed in difference sequences.

Step 1210—Selecting a kernel shape;

Step 1220—Setting a kernel size;

Step 1230—Setting a value contrast threshold; and

Step 1240—Defining kernel sliding.

Selecting a Kernel Shape

The kernel can be of any shape. In an embodiment, a rectangular kernel is useful because camera images typically render pixels in a rectangular grid and because neighboring pixels tend to provide the most relevant information for filtering a pixel's values.

In other embodiments, the kernel can be of other useful shapes. For example, a hexagonal kernel could be used to process images from devices that render pixels in a hexagonal grid. Many other useful kernel shapes are possible; for example triangles, crosses, or diagonals may be used to filter in preferential directions or to increase processing speed.

Setting a Kernel Size

A kernel size is set from the center pixel of a kernel to define which pixels are related for the process of filtering. The kernel size may be either pre-defined or defined based on some criteria of the kernel or the image. A large kernel is effective for filtering noise for an image area with a large number of pixels, but has the disadvantage of suppressing fine details. A smaller kernel tends to preserve fine details better.

In an embodiment, a kernel size of three pixels wide and three pixels tall has been found useful.

Kernels five pixels wide and five pixels tall and seven pixels wide and seven pixels tall are also effective in other embodiments.

Note that, in an alternate embodiment, kernels of varying size may be used dynamically, depending on a specific image's characteristics, as explained below.

Setting a Value Contrast Threshold

To avoid filtering edges and fine details, a value contrast threshold is created for the set of pixels that will be used to compute the filter output for each kernel. For example, a pre-defined value contrast threshold of 2.5 is useful. In other embodiments, statistical methods may be used to set the value contrast threshold.

Also note that, in an alternate embodiment, the value contrast threshold may be set dynamically, depending on a specific image's characteristics, as explained below, so that the selected threshold value is constant for an individual kernel but may vary from kernel to kernel.

Defining Kernel Sliding

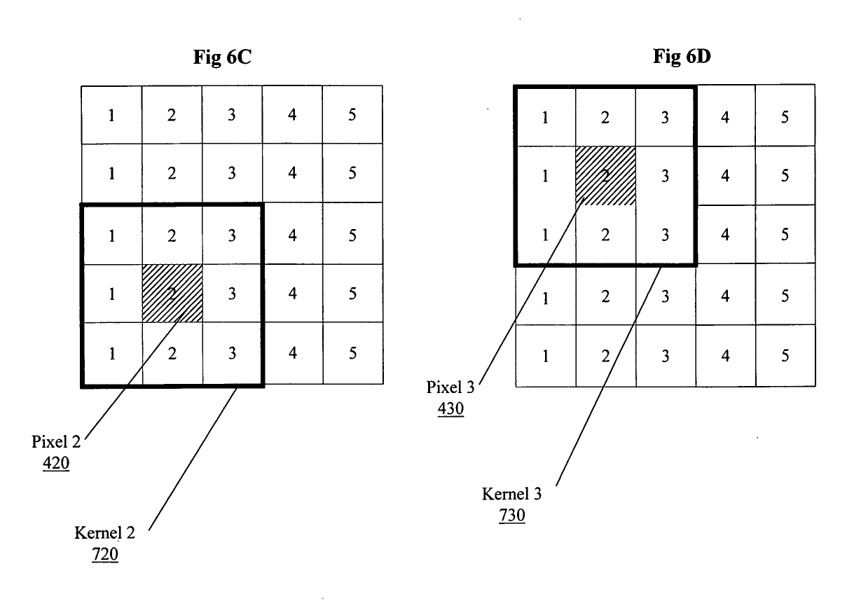

FIGS. 6A, 6B, 6C, 6D, and 6E illustrate the sliding use of a kernel for reducing noise pixel by pixel throughout an image. FIG. 6A shows the pixels of a section of a digital image. In FIG. 6B, kernel 1 710, with dimensions of three pixels by three pixels, has been defined in an area with a center at pixel 1410, for filtering the values of pixel 1 410 to reduce noise. In FIG. 6C a similar kernel 720 is defined in an area with a center at pixel 2 420, and in the same way, in FIG. 6D kernel 730 is centered on pixel 3 430. Thus a kernel of a defined shape and size can be applied to each pixel in an image for processing to reduce noise.

FIG. 6E shows that a kernel 740 for noise reduction can be defined around a center pixel 440 even at the borders of images, in an embodiment. In this case, a supplied vector value, for example [0 0 0], may be used for averaging each pixel missing from the kernel 740.

Computing the Metric Values Inside the Kernel

At each pixel in the image, the metric is computed from the center pixel of the kernel to every other pixel within the kernel.

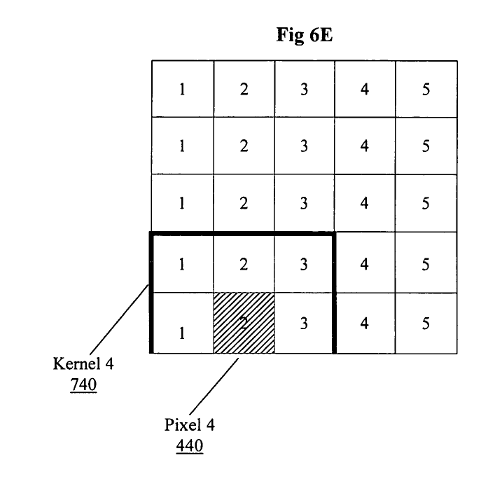

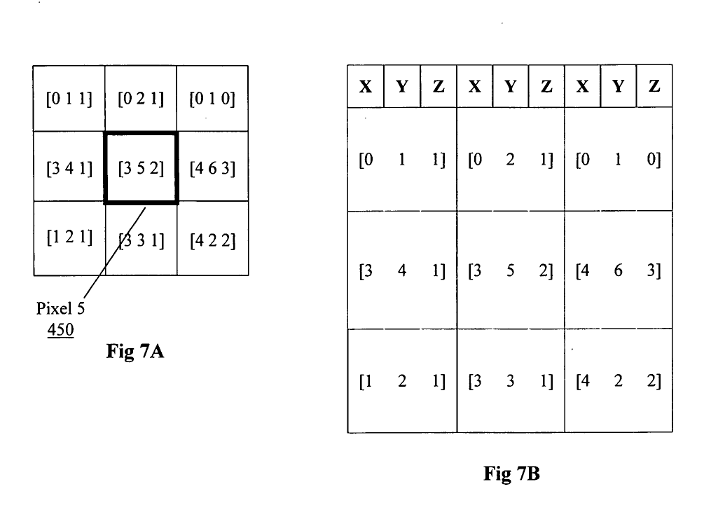

For example, FIG. 7A shows the vector values for the pixels in a kernel section of a digital image. The kernel has dimensions of three pixels by three pixels and is centered on pixel 5 450. The vector values for each pixel represent the red, green, and blue values. Pixel 5 450, for example, has the vector values [3 5 2]. FIG. 7B shows the categorization of these vector values in columns for x, y, and z values, for use with the metric previously determined, where x represent the red values, y represents the green values, and z represents the blue values.

In an embodiment the following metric is used, as described above:
\sqrt{(x₁−x₂)²+(y₁−y₂)²+(z₁−z₂)²}

The pixel in the upper left corner has the following values, which are used for the X₁, Y₁, and Z₁ variables:

X₁=0

Y₁=1

Z₁=1

For the X₂, Y₂, and Z₂ variables, the values of the center pixel 450, as shown in FIG. 6A, of the kernel are used:

X₂=3

Y₂=5

Z₂=2
\sqrt{(0−3)²+(1−5)²+(1−2)²}
\sqrt{26}=5.1

Thus the value derived for the upper left pixel of the kernel is 5.1.

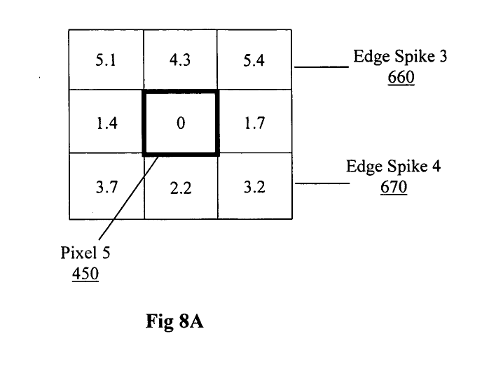

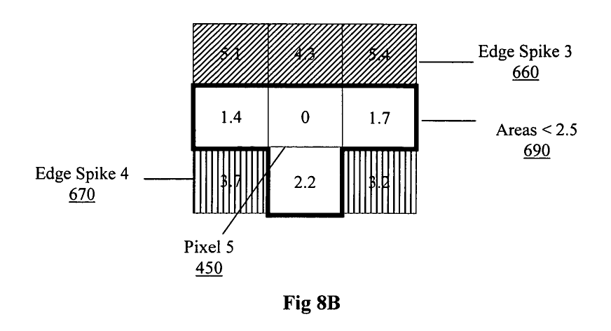

FIG. 8A shows the derived values for all the pixels in the kernel. Note that the derived value for the center pixel 450 is 0, since the center pixel's 450 values are subtracted from themselves.

In an embodiment, the value contrast threshold 2.5 cited above is then applied to the values derived by the metric. FIG. 8B shows the pixels 690 in the kernel that have derived values below 2.5 and that will be used as the specified set of pixels for filtering of center pixel 450 by averaging.

The pixels with derived values above 2.5, shown as occurring in edge spike 3 660 and edge spike 4 670, represent edges and to avoid distortion will not be used for averaging, in an embodiment.

Thresholding the Values to Select Relevant Pixels

A statistical measurement (for example, the mean or median, computed on vector values) of the specified set of pixels within each kernel is computed.

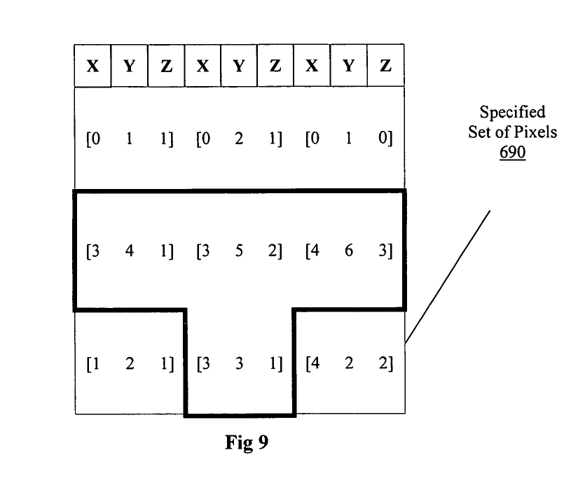

To continue with the running example, FIG. 9 shows the vector values of the specified set of pixels shown in FIG. 8B. In an embodiment, the vector values of these pixels can be added as follows:

X values: 3+3+4+3=13

Y values: 4+5+6+3=18

Z values: 1+2+3+1=7

In an embodiment, means averages of each of these sums may then be made, by dividing each sum by four, which is the number of values added together for each sum.

X value: 13/4=3.2

Y value: 18/4=4.5

Z value: 7/4=1.7

The statistical measurement for this example is thus 3.2 (red), 4.5 (green), and 1.7 (blue).

Filtering Using the Selected Values to Replace the Center Pixel

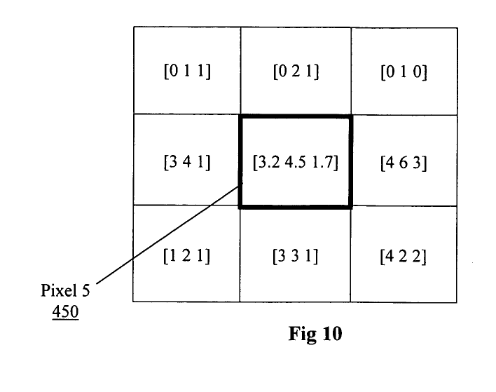

The computed statistical measurement is made the new value of the center pixel in each kernel in the image. FIG. 10 shows that the statistical measurement for the running example [3.2 4.5 1.7], is used as a filtered value for center pixel 5 450, replacing the previous values for that pixel 450.

In the same way, kernels are centered on each pixel in the image, the entire process given above, comprising computing the metric, thresholding, and filtering using statistical measurements, is made, and filtered values are used for each center pixel, resulting in reduced noise while preserving edges and fine details.

Use of the Filtering Software

After filtering software 200, shown in FIG. 4 has been created, server 100 can receive a digital image 310 from a device such as computer 150 and automatically run filtering software 200 on digital image 310 in volatile memory to create a filtered image 340 with reduced noise. Server 100 then automatically sends the filtered image 340 back to computer 150.

Comparison with Results from Prior Techniques

It will be useful to compare the results of noise filtering through the embodiment of the present invention given above with those obtainable through prior techniques.

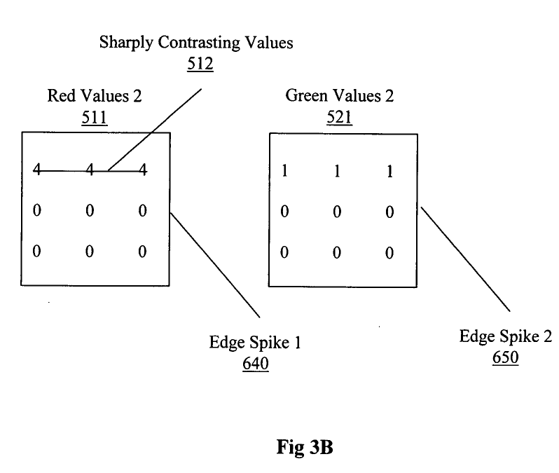

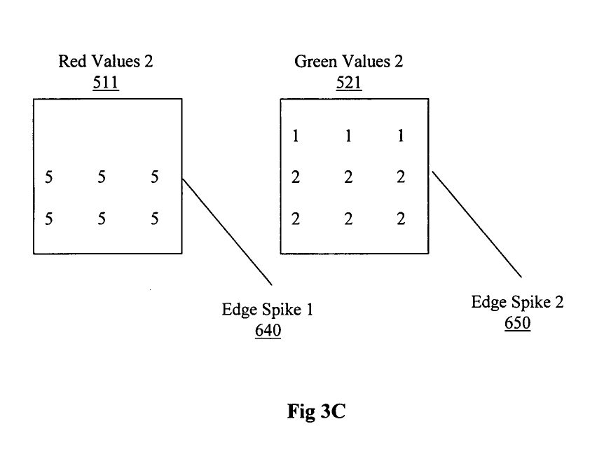

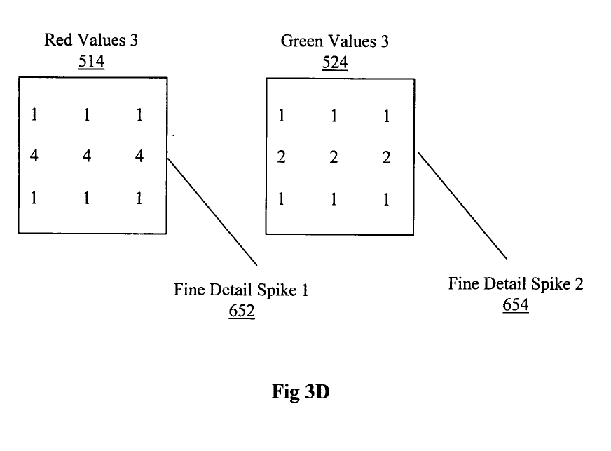

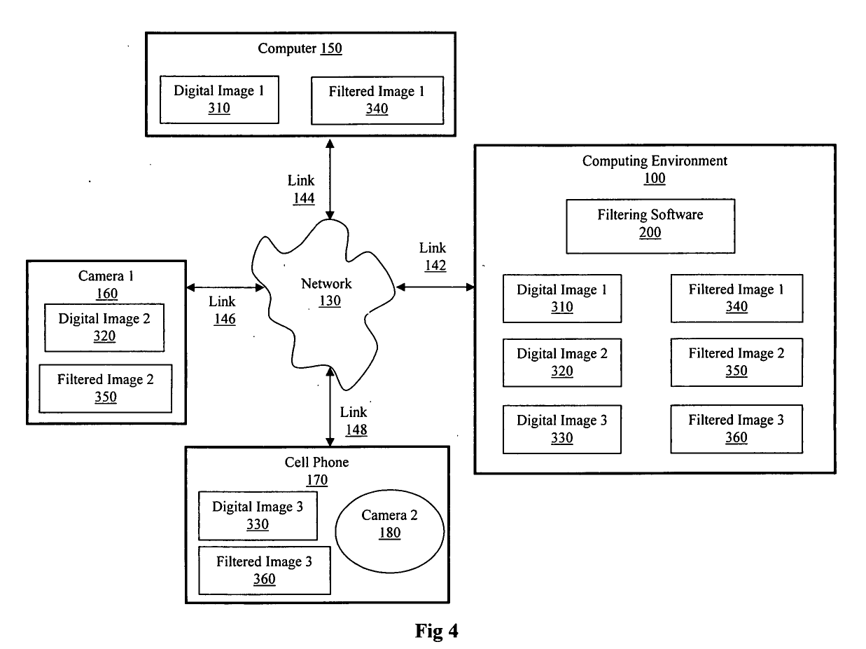

Returning to FIG. 3A, the red and green pixel values for a common area of an image with an edge spike contain a center pixel value of [5 2].

An embodiment of the present invention would perform noise reduction on this area and still yield a replacement value for the center pixel of [5 2]. This preserves both the intensity of the edge and the color balance between the red and green values.

But the typical prior technique of spatial filtering, explained above, gives a replacement value of [5 1.7]. This softens the edge and distorts the color balance of the image.

Similarly favorable results apply to areas with fine details. As explained above, FIG. 3D shows the red and green pixel values for a common area of an image containing a fine detail spike and containing a center pixel value of [4 2].

Again, an embodiment of the present invention would perform noise reduction on this area and still yield a replacement value for the center pixel of [4 2]. This preserves both the intensity of the fine detail and the color balance between the red and green values.

However, the typical prior technique of spatial filtering, explained above, gives a replacement value of [4 1.3], which softens the fine detail and distorts the color balance of the image.

Dynamically Setting a Kernel Size

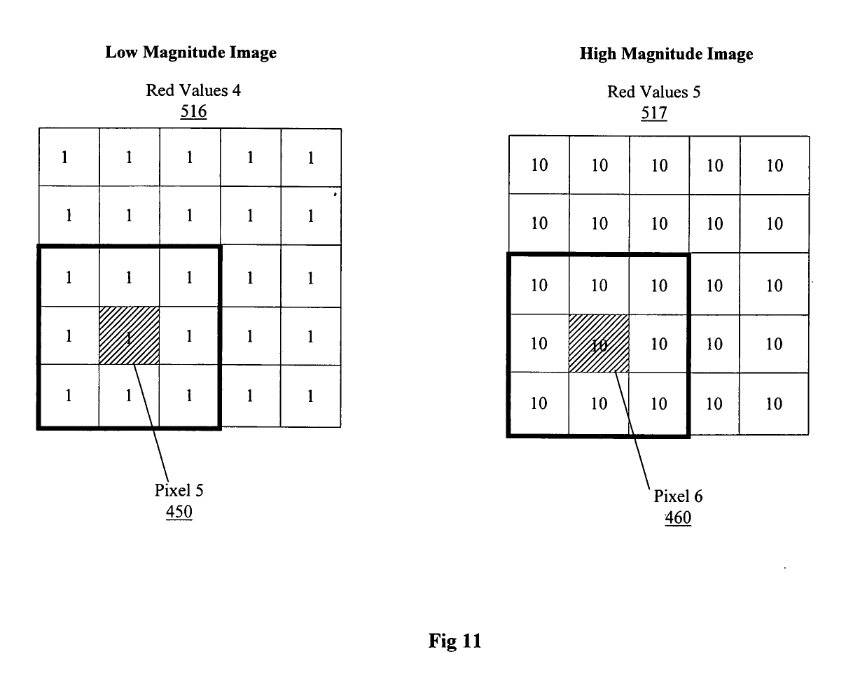

In an alternate embodiment, the size of the processing kernel can be set dynamically. Because noise is a random value in images, it is more pronounced in low-value areas. For example, FIG. 11 shows the red values of two different images. The image with red values 4 516 is low value, since all its pixel values are 1. A change in intensity in pixel 5 from 1 to 3 because of noise represents a relatively large percentage increase in value. On the other hand, the image with red values 5 517, where all the pixel values are 10, is high value, and a change in intensity in pixel 6 from 10 to 12, because of noise, represents a lower percentage increase in value.

Because of these characteristics, it may be useful for filtering software 200 to be set up to change the size of the processing kernel dynamically based on the intensity of an image and on a magnitude threshold value. Specifically, after using a magnitude threshold value to detect that an image is of low intensity, filtering software 200 will calculate a larger processing kernel for the image than 3 pixels by 3 pixels, for example a processing kernel of 5 pixels by 5. The useful increase in kernels size is calculated for successive pixel increases, 5×5, 7×7, 9×9, and so on.

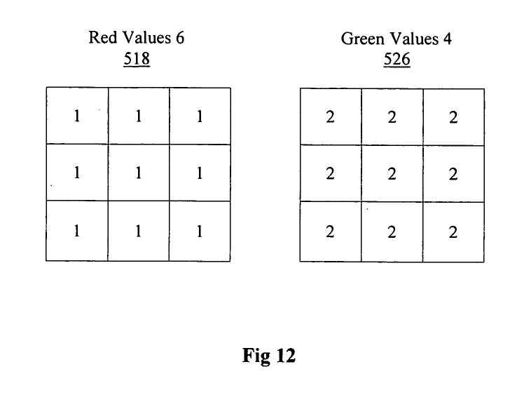

For example, in an embodiment filtering software 200 can be created using a magnitude threshold value of below 50 to identify low-value images. To illustrate how such a magnitude threshold can be used, FIG. 12 shows the red values 518 and green values 526 of a common area of an image. The vector magnitude within an area of an image may be defined as
\sqrt{r²+g²}
In the case of the area in FIG. 12, the vector magnitude can be calculated as follows:
\sqrt{1²+2²}=\sqrt{5}

Add all the magnitudes within the kernel, and the result in a value of 20.1.

Because 20.1 is under the defined magnitude threshold of 50, the area will be considered low value, and a larger kernel size of 5 pixels by 5 pixels will be considered for filtering. Add all the magnitudes within the kernel, and the result is 56. Because 56 is larger that the magnitude threshold of 50, there is no need to increase the kernel further to 7 pixels×7 pixels; the kernel is large enough for meaningful averaging.

In another embodiment, the magnitude threshold can be set as the standard deviation of the magnitude of the overall image subtracted from the mean overall magnitude.

Dynamically Setting a Value Contrast Threshold

In an alternate embodiment, the value contrast threshold used with a kernel can also be set dynamically, through a statistical method. For example, one can take the mean average of the values in the kernel, find the standard deviation, and set the value contrast threshold to the mean value plus the standard deviation.

Sharpening

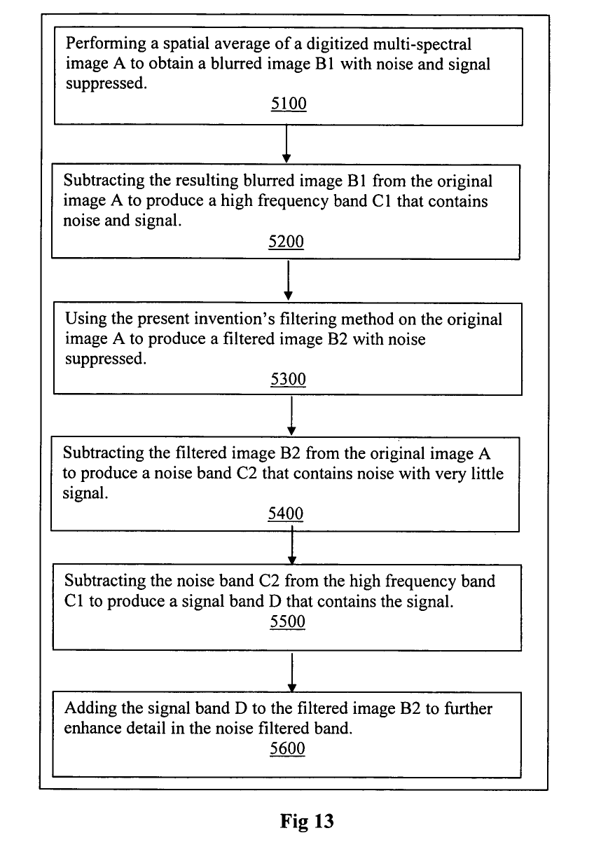

Prior techniques of sharpening images depend on sharpening independent scalar layers, not vector values. However, the ability of the present invention's filtering process to preserve edges and fine details in vector values can also be used to enhance or sharpen images. FIG. 13 shows a process for sharpening images by enhancing image detail that can be accomplished by using the present invention, in an embodiment.

Step 5100—Performing a spatial average of a digitized multi-spectral image A to obtain a blurred image B1 with noise and signal suppressed.

Step 5200—Subtracting the resulting blurred image B1 from the original image A to produce a high frequency band C1 that contains noise and signal.

Step 5300—Using the present invention's filtering method on the original image A to produce a filtered image B2 with noise suppressed.

Step 5400—Subtracting the filtered image B2 from the original image A to produce a noise band C2 that contains noise with very little signal.

Step 5500—Subtracting the noise band C2 from the high frequency band C1 to produce a signal band D that contains the signal.

Step 5600—Adding the signal band D to the filtered image B2 to further enhance detail in the noise filtered band.

Computer System Overview

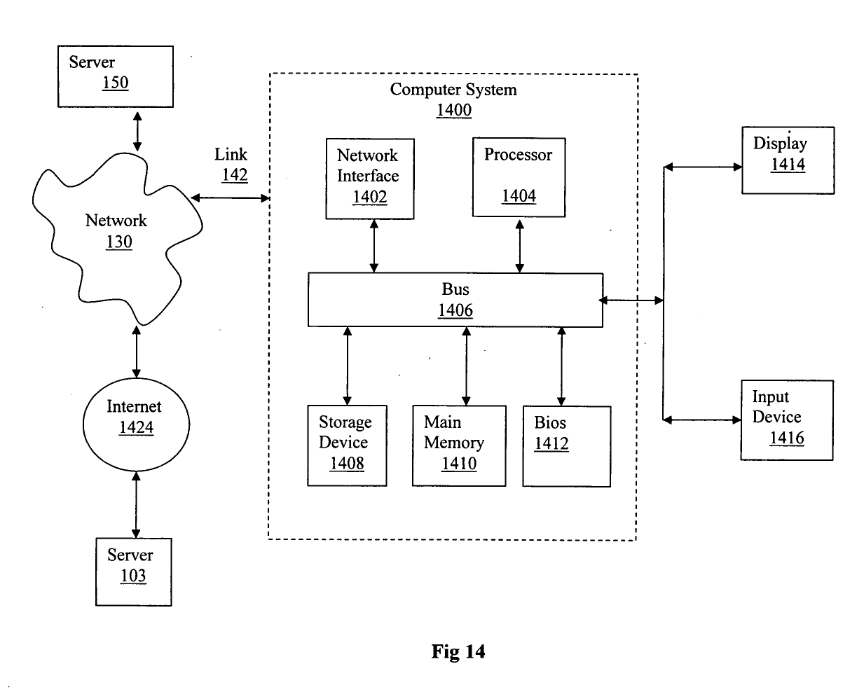

FIG. 14 is a block diagram that illustrates an example of a typical computer system 1400, well known to those skilled in the art, representing a computing environment 100 on which embodiments of the present invention can be implemented. This computer system 1400 comprises a network interface 1402 that provides two-way communications through a wired or wireless link 142 to a wired or wireless communications network 130 that uses any applicable communications technology. For example, the network 130 can comprise a public telephone network, a wireless network, a local area network (LAN), and any known or not-yet-know applicable communications technologies, using correspondingly applicable links. The network 130 in turn provides communications with one or more host computers 150 and, through the Internet 1424, with one or more servers 103.

The network interface 1402 is attached to a bus 1406 or other means of communicating information. Also attached to the bus 1406 are the following:
a processor 1404 for processing information;
a storage device 1408, such as an optical disc, a magneto-optical disc, or a magnet disc, for storing information and instructions;
main memory 1410, which is a dynamic storage device such as a random access memory (RAM) that stores information and instructions to be carried out by processor 1404;
a bios 1412 or another form of static memory such as read only memory (ROM), for storing static information and instructions to be carried out by processor 1404;
a display 1414, such as a liquid crystal display (LDC) or cathode ray tube (CRT) for displaying information to user of the computer system 1400; and
an input device 1416, with numeric and alphanumeric keys for communicating information and commands to processor 1404. In another embodiment a mouse or other input devices can also be used.

The computer system 1400 is used to implement the methods of the present invention in one embodiment. However, embodiments of the present invention are not limited to specific software and hardware configurations. Computer system 1400 can receive data comprising client application messages from computer 150 and server 103 used by client business, through a network 130 such as the Internet, an appropriate links 142, such as wired or wireless ones, and its network interface 1402. It can of course transmit data back to client business application over the same routes.

Computer system 1400 carries out the methods of the present invention when its processor 1404 processes instructions contained in its main memory 1410. Another computer-readable medium, such as its storage device 1408, may read these instructions into main memory 1410 and may do so after receiving these instructions through network interface 1402. Processor 1404 further processes data according to instructions contained in its storage device 1408. Data is relayed to appropriate elements in computer system 1400 through its bus 1406. Instructions for computer system 1400 can also be given through its input device 1416 and display 1414.

“Computer-readable medium” refers to any medium that provides instructions to processor 1404, comprising volatile, non-volatile, and transmission media. Volatile media comprise dynamic memory, such as main memory 1410. Non-volatile media comprise magnetic, magneto-optical, and optical discs, such as storage device 1408. Transmission media comprise a wide range of wired and unwired transmission technology, comprising cables, wires, modems, fiber optics, acoustic waves, such as radio waves, for example, and light waves, such as infrared, for example. Typical examples of widely used computer-readable media are floppy discs, hard discs, magnetic tape, CD-ROMs, punch cards, RAM, EPROMs, FLASH-EPOMs, memory cards, chips, and cartridges, modem transmissions over telephone lines, and infrared waves. Multiple computer-readable may be used, known and not yet known, can be used, individually and in combinations, in different embodiments of the present invention.

Alternate Embodiments

The previous extended description has explained some of the alternate embodiments of the present invention. It will be apparent to those skilled in the art that many other alternate embodiments of the present invention are possible without departing from its broader spirit and scope.

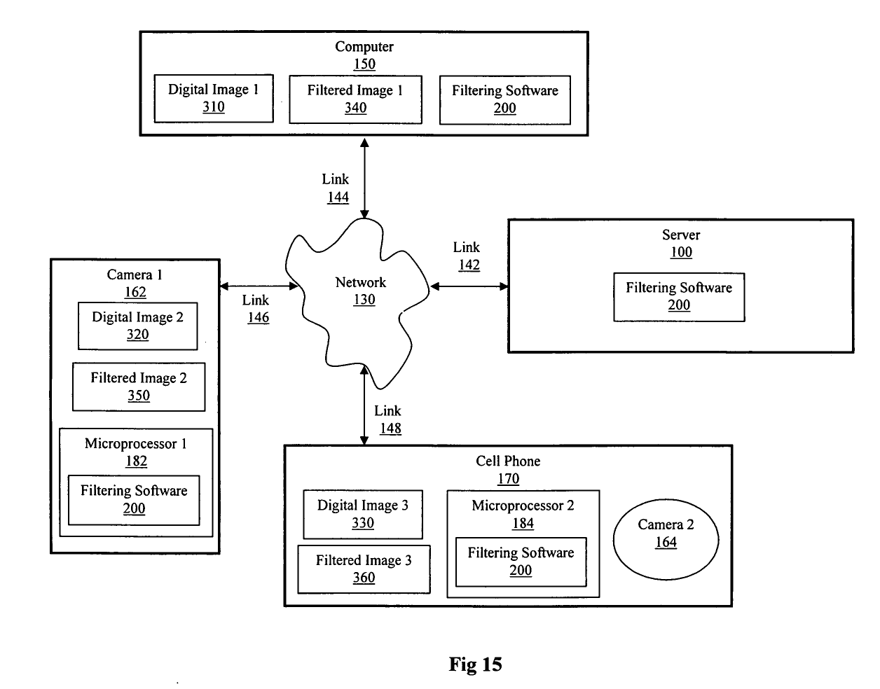

For example, FIG. 15 shows an operating environment where one or more programmers at server 100 create filtering software 200. Filtering software 200 can then be transmitted to computer 150 and used there to process images such as digital image 1 310 and produce filtered image 1 340, in which noise is suppressed.

Filtering software 200 can also be placed on microprocessors, such as microprocessor 1 182 and microprocessor 2 184, and the microprocessors can be loaded on appropriate devices, such as camera 1 162 and cell phone 170, so that filtering of digital images can be accomplished on these devices.

It will also be apparent to those skilled in the art that different embodiments of the present invention may employ a wide range of possible hardware and of software techniques. For example, the communication between x and client business computers could take place through any number of links, including wired, wireless, infrared, or radio ones, and through other communication networks beside those cited, including any not yet in existence.

Also, the term computer is used here in its broadest sense to include, for example, personal computers, laptops, telephones and cell phones with computer capabilities, cameras, personal data assistants (PDAs) and servers, and it should be recognized that it could include multiple servers, with storage and software functions divided among the servers. A wide array of operating systems, compatible e-mail services, Web browsers and other communications systems can be used to transmit messages among client applications and Web services.

Furthermore, in the previous description the order of processes, their numbered sequences, and their labels are presented for clarity of illustration and not as limitations on the present invention.

What is claimed is:

1. An automated method for filtering digitized multi-spectral images to suppress noise, the images comprising a plurality of pixels, the pixels each having vector values comprising a plurality of spectral components, the method comprising the computer-implemented steps of
creating filtering software, such that the filtering software filters an image according to the vector values of at least a portion of the plurality of pixels within the image;
receiving a digital image;
filtering the digital image using the filtering software; and
returning a filtered image.

2. The method of claim 1 wherein the vector values of at least a portion of the plurality of pixels further comprise
a red scalar color component value for each of the plurality of pixels;
a green scalar color component value for each of the plurality of pixels; and
a blue scalar color component value for each of the plurality of pixels.

3. The method of claim 1 wherein the vector values of at least a portion of the plurality of pixels further comprise
a cyan scalar color component value for each of the plurality of pixels;
a magenta scalar color component value for each of the plurality of pixels;
a yellow scalar color component value for each of the plurality of pixels; and
a black scalar color component value for each of the plurality of pixels.

4. The method of claim 1 wherein creating filtering software, such that the filtering software filters an image according to the vector values of the plurality of pixels within the image further comprises
defining a metric, such that the metric uses the vector values of a first pixel and a second pixel to determine a metric value for the pixel; and
filtering each of the portion of the plurality of pixels within the image by designating a center pixel;
defining a sliding processing kernel relative to the center pixel, the kernel comprising kernel pixels which include the center pixel and a plurality of pixels in proximity to the center pixel;
for each pixel associated with the sliding processing kernel
using the metric to compute the metric value for the pixel from the center pixel vector value and the pixel vector value,
comparing the metric value for the pixel to a threshold value for the kernel pixels in order to determine whether to include the pixel value in a filter calculation for the center pixel,
performing the filter calculation for the center pixel using the metric values for the those kernel pixels which were determined to be included in the filter calculation, and
replacing the vector value of the center pixel with a calculated vector value from the filter calculation for the center pixel.

5. The method of claim 4 wherein defining a metric further comprises
determining the simple vector distance between the vector values of the center pixel and a second pixel.

6. The method of claim 4 wherein defining a sliding processing kernel relative to the center pixel further comprises
selecting a kernel shape relative to the center pixel;
setting a kernel size; and
setting a value contrast threshold for the kernel.

7. The method of claim 6 wherein setting a kernel size further comprises
setting a kernel size dynamically based on the intensity of an image and on a magnitude threshold value.

8. The method of claim 7 wherein setting a kernel size dynamically based on the intensity of an image and on a magnitude threshold value further comprises
using the magnitude threshold value to detect that a portion of an image is of low intensity; and
setting a large kernel size for the low intensity portion of an image.

9. The method of claim 8 wherein using a magnitude threshold value to detect that an image is of low intensity further comprises
setting the magnitude threshold value as the standard deviation of the magnitude of the overall image subtracted from the mean overall magnitude of the image.

10. The method of claim 7 wherein setting a value contrast threshold for the kernel further comprises
using a statistical method to set a value contrast threshold.

11. The method of claim 7 wherein setting a value contrast threshold further comprises
setting a value contrast threshold dynamically through a statistical method comprising
taking the mean average of the vector values of the pixels in the kernel;
finding the standard deviation of the vector values of the pixels in the kernel; and
setting the value contrast threshold to the mean average plus the standard deviation.

12. An automated method for filtering digitized multi-spectral images to suppress noise, the images comprising a plurality of pixels, the pixels each having vector values comprising a plurality of spectral components, the method comprising the computer-implemented steps of
creating filtering software, such that the filtering software filters an image according to the vector values of the plurality of pixels within the image by
defining a metric, such that the metric uses the vector values of a first pixel and a second pixel to determine a metric value for the pixel, and
filtering each of the portion of the plurality of pixels within the image by designating a center pixel,
defining a sliding processing kernel relative to the center pixel, the kernel comprising a plurality of kernel pixels by
selecting a kernel shape relative to the center pixel, such that the kernel comprises the center pixel and a plurality of pixels in proximity to the center pixel,
setting a kernel size, and
setting a value contrast threshold for the kernel, and
for each kernel pixel,
using the metric to compute the metric value for the pixel from the center pixel vector value and the pixel vector value,
comparing the metric value for the pixel to a threshold value for the kernel pixels in order to determine whether to include the pixel value in a filter calculation for the center pixel,
performing the filter calculation for the center pixel using the metric values for those kernel pixels which were determined to be included in the filter calculation, and
replacing the vector value of the center pixel with a calculated vector value from the filter calculation for the center pixel;
receiving a digital image;
filtering the digital image using the filtering software; and
returning a filtered image.

13. The method of claim 12 wherein the vector values of at least a portion of the plurality of pixels further comprise
a red scalar color component value for each of the plurality of pixels;
a green scalar color component value for each of the plurality of pixels; and
a blue scalar color component value for each of the plurality of pixels.

14. The method of claim 12 wherein defining a metric further comprises
determining the simple vector distance between the vector values of the center pixel and a second pixel.

15. The method of claim 12 wherein setting a kernel size further comprises setting a kernel size dynamically based on the intensity of an image and on a magnitude threshold value by
using the magnitude threshold value to detect that a portion of an image is of low intensity; and
setting a large kernel size for the low intensity portion of an image.

16. The method of claim 15 wherein using a magnitude threshold value to detect that an image is of low intensity further comprises
setting the magnitude threshold value as the standard deviation of the magnitude of the overall image subtracted from the mean overall magnitude of the image.

17. The method of claim 12 wherein setting a value contrast threshold for the kernel further comprises
using a statistical method to set a value contrast threshold.

18. The method of claim 17 wherein setting a value contrast threshold further comprises
setting a value contrast threshold dynamically through a statistical method, the statistical method comprising
taking the mean average of the vector values of the pixels in the kernel;
finding the standard deviation of the vector values of the pixels in the kernel; and
setting the value contrast threshold to the mean average plus the standard deviation.

19. A method of sharpening digitized multi-spectral images, the method comprising performing a spatial average of a digitized multi-spectral image A to obtain a blurred image B1 with noise and signal suppressed;
subtracting the resulting blurred image B1 from the original image A to produce a high frequency band C1 that contains noise and signal;
using filtering software based on vector values of pixels in the original image A to produce a filtered image B2 with noise suppressed;
subtracting the filtered image B2 from the original image A to produce a noise band C2 that contains noise with very little signal;
subtracting the noise band C2 from the high frequency band C1 to produce a signal band D that contains the signal; and
adding the signal band D to the filtered image B2 to further enhance detail in the noise filtered band.

20. A system for filtering digitized multi-spectral images to suppress noise, the system comprising
a computing environment;
means for receiving a digitized multi-spectral image from a source environment;
filtering software based on vector values of a plurality of pixels within the image, the software providing a filtered image by
defining a metric, such that the metric uses the vector values of a first pixel and a second pixel to determine a metric value for the pixel, and
filtering each of the portion of the plurality of pixels within the image by designating a center pixel,
defining a sliding processing kernel relative to the center pixel, the kernel comprising kernel pixels which include the center pixel and a plurality of pixels in proximity to the center pixel,
for each pixel associated with the sliding processing kernel
using the metric to compute the metric value for the pixel from the center pixel vector value and the pixel vector value, and
comparing the metric value for the pixel to a threshold value for the kernel pixels in order to determine whether to include the pixel value in a filter calculation for the center pixel,
performing the filter calculation for the center pixel using the metric values for the those kernel pixels which were determined to be included in the filter calculation, and
replacing the vector value of the center pixel with a calculated vector value from the filter calculation for the center pixel; and
a means for transmitting the filtered image to a target environment.

22. A system for providing filtered digitized multi-spectral images, the system comprising
a means of capturing digitized multi-spectral images; and
a microprocessor containing filtering software based on vector values of a plurality of pixels within the image, the software providing a filtered image by
defining a metric, such that the metric uses the vector values of a first pixel and a second pixel to determine a metric value for the pixel; and
filtering each of the portion of the plurality of pixels within the image by designating a center pixel,
defining a sliding processing kernel relative to the center pixel, the kernel comprising kernel pixels which include the center pixel and a plurality of pixels in proximity to the center pixel,
for each pixel associated with the sliding processing kernel
using the metric to compute the metric value for the pixel from the center pixel vector value and the pixel vector value, and
comparing the metric value for the pixel to a threshold value for the kernel pixels in order to determine whether to include the pixel value in a filter calculation for the center pixel,
performing the filter calculation for the center pixel using the metric values for the those kernel pixels which were determined to be included in the filter calculation, and
replacing the vector value of the center pixel with a calculated vector value from the filter calculation for the center pixel.
